(19) United States
(12) Patent Application Publication
(10) Pub. No.: US 2026/0160656 A1
(43) Pub. Date: Jun. 11, 2026

(54) DEVICE FOR CRYOGENICS AND HEATING OF REDUCED-SCALE TEST SPECIMENS FOR CHARPY TESTING

(71) Applicants: Petróleo Brasileiro S.A. – Petrobras, Rio de Janeiro (BR); Universidade Federal de Uberlândia, Uberlândia (BR)

(72) Inventors: Sinésio Domingues FRANCO, Uberlândia (BR); Rosenda Valdés ARENCIBIA, Uberlândia (BR); Regina Paula Garcia MOURA, Uberlândia (BR); Rafael Marques Pacheco BORGES, Uberlândia (BR); Pedro Augusto Queiroz DE ASSIS, Uberlândia (BR); Marcelo Torres Piza PAES, Rio de Janeiro (BR); Juliano Oséias DE MORAES, Uberlândia (BR); Guilherme Henrique Alves ANDRADE, Uberlândia (BR); Dênis Soares DE FREITAS, Uberlândia (BR); Daniel Correia Freire FERREIRA, Rio de Janeiro (BR); Artur Martins ALVES, Uberlândia (BR)

(21) Appl. No.: 19/402,471

(22) Filed: Nov. 26, 2025

(30) Foreign Application Priority Data
Dec. 5, 2024 (BR) 1020240253876

(51) Int. Cl. G01N 3/30

(52) U.S. Cl. CPC G01N 3/30; G01N 2203/001; G01N 2203/0098; G01N 2203/0226; G01N 2203/0228

(57) ABSTRACT

The present invention relates to a climate-control device (cryogenic cooling and heating) for reduced-scale test specimens for Charpy impact testing under thermal loading. This device has the ability to cool or heat test specimens within a range of from −180° C. to 110° C., and allow them to be placed on the stop of the testing machine undergoing minimal thermal variation (either endothermic or exothermic). Therefore, it falls within the field of mechanical testing under thermal loading, that is, when the test specimen or sample is subjected to prior conditioning (either cooling or heating) before undergoing the respective mechanical experiment. The aim of this type of test is to study how the mechanical strength of a material is affected by conditions such as very low or very high temperatures. This allows the determination of the ductile-brittle transition curve.

### CROSS-REFERENCE TO RELATED APPLICATIONS

This application claims priority to Brazilian Patent Application No. 1020240253876, filed Dec. 5, 2024, which is incorporated herein in its entirety by reference thereto.

### BACKGROUND OF THE INVENTION

### Field

The present disclosure relates to a climate-control device (cryogenic cooling and heating) for reduced-scale test specimens for Charpy impact testing under thermal loading. This device has the ability to cool or heat test specimens within a range of from 190° C. to 110° C., and allow them to be placed on the stop of the testing machine undergoing minimal thermal variation (either endothermic or exothermic). Therefore, it falls within the field of mechanical testing under thermal loading, that is, when the test specimen or sample is subjected to prior conditioning (either cooling or heating) before undergoing the respective mechanical experiment. The aim of this type of test is to study how the mechanical strength of a material is affected by conditions such as very low or very high temperatures. This allows the determination of the ductile-brittle transition curve.

The device of the present disclosure is operated and controlled by a supervisory interface software with its own programming, being responsible for controlling the process for thermal preparation of reduced-scale test specimens for Charpy impact testing. It is a source program provided with its own programming lines and an original source language (Python, PY), responsible for setting the thermal parameters, which can be either cryogenics or heating, representing an associated operational methodology Therefore, it contributes to the performance of thermally loaded mechanical impact tests.

### BACKGROUND

The Charpy test is a standardized method for measuring the toughness and strength of a material by measuring the rate of destruction and how much that material was resilient to the blow of an impact mass. Thus, the energy transmitted by the impact mass that is absorbed by the material under analysis is a measurement based on a given strength material and acts as a tool to study the ductile/brittle properties. It is widely used in industry for being easy to perform, and the results can be obtained quickly and at low cost. One drawback is that some results are only comparative.

It is one of the most widely used methods for the characterization of materials. These tests are dynamic and are characterized by the fact that force is applied to the test specimens through the impact between the test specimen and a falling pendulum. This type of test is capable of measuring the energy required to cause the test specimen to fail. This test method specifically refers to the behavior of metallic materials when subjected to a single impact load, resulting in multiaxial stress conditions associated with a notch. With this normal stress at the notch base, there is a tendency for fracture to begin in the specimen. The property that either prevents or allows the test specimen to break is cohesive force. The bar fractures when the normal stress exceeds the material's cohesive strength. When this occurs without the bar undergoing deformation, it is indicative of a condition for brittle fracture (ASTM E23, 2023).

When the material under analysis is subjected to temperature variation, its mechanical behavior changes, reflecting in the way its fracture is characterized. Therefore, a ductile-brittle transition curve can be described, which expresses the typical results of a given material when it is fractured at various spots along a thermal gradient. Such ductile-brittle transition curve is designed from tests performed under different temperature conditions, showing a correlation between impact energy and point temperature. Therefore, the fractured surface of a material can indicate its behavior, being either ductile (fracture surface is fibrous and opaque) or brittle (fracture surface is granular and shiny).

The most widely known impact tests are the Charpy and Izod tests. The basic differences between Charpy and Izod tests is how the test specimen is assembled (either horizontal or vertical), and the notch face being either located or not in the impact region. Variables such as the size and shape of the test specimen, the depth and configuration of the notch affect the test results. Impact energies are of interest for comparing different materials (GARCIA, A. ; SPIM, J. A. ; SANTOS, C. A. Ensaios dos Materiais. Rio de Janeiro: LTC, 2000).

### STATE OF THE ART

Brazilian patent BR 10 2012 010567-5 A2 relates to an Automatic Sample Positioning System for Charpy Impact Testing, with an associated device for cooling or heating these samples in a controlled environment. It is capable of cooling samples down to −40° C. and heating them up to 100° C. It comprises an actuator, which may be a hydraulic or electromechanical piston responsible for displacing the thermally conditioned sample and placing it at the impact stop of the Charpy testing machine. The inventors state that this apparatus can be installed on various models of Charpy impact testing machines available on the market.

CN206488988U refers to a kind of testing device for cryogenic mechanical performance that can be adapted to universal tensile testers and is capable of cooling test specimens using a cryogenic liquid. The mechanism describes a receptacle in which the specimen holding clamps are immersed together with the specimen in the cryogenic liquid. After reaching the target temperature, the clamps with the test specimen thereon are removed from the cooling compartment and placed in the universal tensile tester.

WO2010008083A1 refers to a refrigeration and cold storage system in a sample test tube. A superior and easy-to-use refrigeration and cold storage device for specimen test tubes is provided. The refrigeration and cold storage device for specimen test tubes can be used soon after being taken out of a freezer, satisfying two conflicting requirements, namely fast cooling of the specimen and cold storage for a long period of time, and can be used in clinical settings.

KR101074714B1 refers to an automatic cooling apparatus for shock testing specimens. This is an automatic specimen cooling device designed to cool a large number of impact-test specimens and to stack and extract them sequentially, comprising:
a tray for holding a large number of specimens;
a tray handling unit for loading one or more trays and lifting and lowering them so as to stack them and extract them sequentially;
a lifting/lowering unit formed by a structure in which a screw, rotated by a drive motor that operates the tray handling unit, and a guide shaft that adjusts the height of the tray handling unit are interconnected to guide the height of the tray handling unit;
a control unit that controls the lifting/lowering unit, adjusts the height of stepwise immersion of the tray, and detects a change in the height of the tray handling unit according to the height of the tray being immersed and extracted;
a cooling tank in which an immersion space for trays loaded with specimens is provided, and which cools the specimens to a low-temperature or cryogenic state using a cooling solution;
and a lid operated by a cylinder that opens and closes the cooling tank along a guide rail. At least one specimen cooling structure, including the above, is provided to cool a large number of specimens, and a tray loaded with cooled specimens is removed by a transport robot to select a required specimen and perform an impact test.

CN202974790U refers to a multi-specimen testing machine applied to thermal fatigue experiments. The multi-specimen testing machine comprises a heater, a water tank and a specimen clamp, wherein the specimen clamp is fixed on a turntable in the water tank and is of a similar waterwheel structure; the turntable is linked with a stepping motor of which the rear is connected with a stabilized voltage supply through a belt; the front of the turntable is aligned with the heater and a thermocouple sensor; the specimen temperature is detected through a semicircular thermocouple on the turntable; the thermocouple sensor transmits the heating and cooling frequency to a counter above the heater; and the operating steps of the multi-specimen testing machine are systematically controlled through the control system. According to the mode, the multi-specimen testing machine applied to the thermal fatigue experiment is provided, the design of multiple heating stations is adopted, multiple specimen clamps can be arranged on the turntable for clamping specimens, the specimens are simultaneously heated by utilizing high-frequency induction, the turntable is rotated, the specimens are immersed in the water tank for cooling, and the specimens are positioned in the identical testing environment.

### Problems Found in the State of the Art

The devices disclosed in the prior art are not capable of thermally preparing specimens manufactured reduced scale for Charpy impact testing, nor do they cover the temperature range from −190° C. to “110 °C.”

### Proposed Solution to the Problem

The device of the present disclosure is capable of accommodating, handling, and thermally preparing specimens on a reduced scale compared to conventional specimen geometries used in Charpy impact tests. For this purpose, it is provided with a chamber adapted to accommodate a specific container that receives and places the test specimen at such reduced scales. Therefore, the entire thermal preparation system is influenced by these reduced scale dimensions in relation to the standard dimensions according to ASTM E23.

Furthermore, the present device is also capable of preparing specimens at temperatures down to −190° C. through a cryogenic process, or up to 110° C. through a heating process. For cryogenics, the device uses a cryogenic gas that is injected into channels specifically designed for this purpose. For heating, the device uses an electrical resistor installed in other channels for this second purpose, producing a physical phenomenon designated as the Joule effect where electrical energy is transformed into thermal energy.

### BRIEF DESCRIPTION OF THE DRAWINGS/FIGURES

### List of Figures

The present disclosure can be better understood based on the attached figures, wherein:

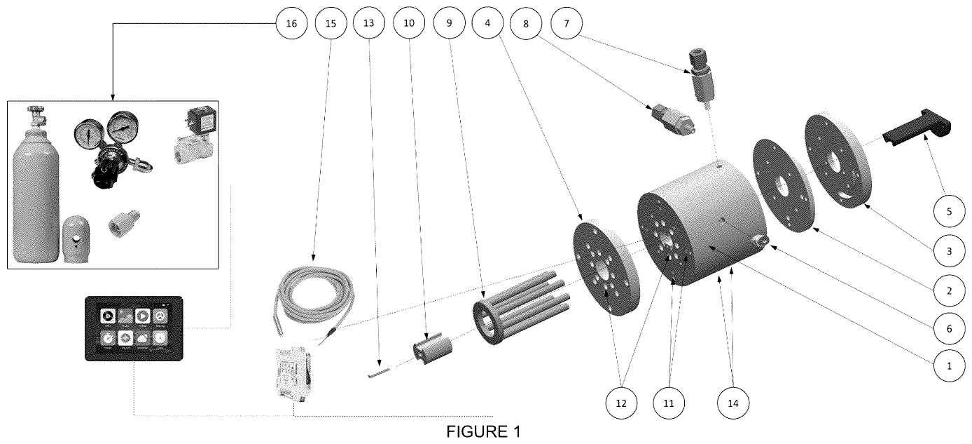

FIG. 1 shows the cryogenics and heating device in isometric, exploded view, with its assembly elements highlighted with their respective identification numbers.

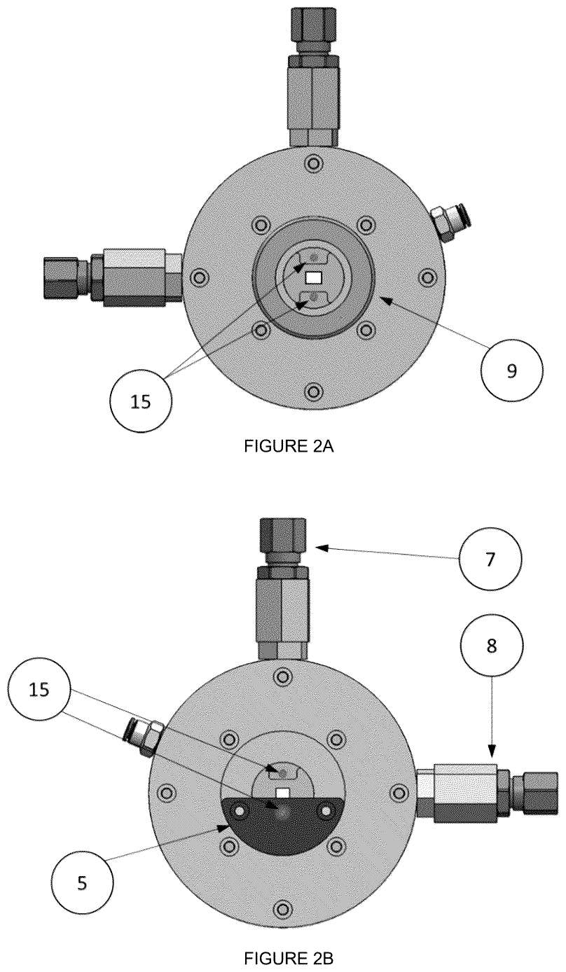

FIG. 2A shows the front view of the cryogenics and heating device.

FIG. 2B shows the review view of the cryogenics and heating device.

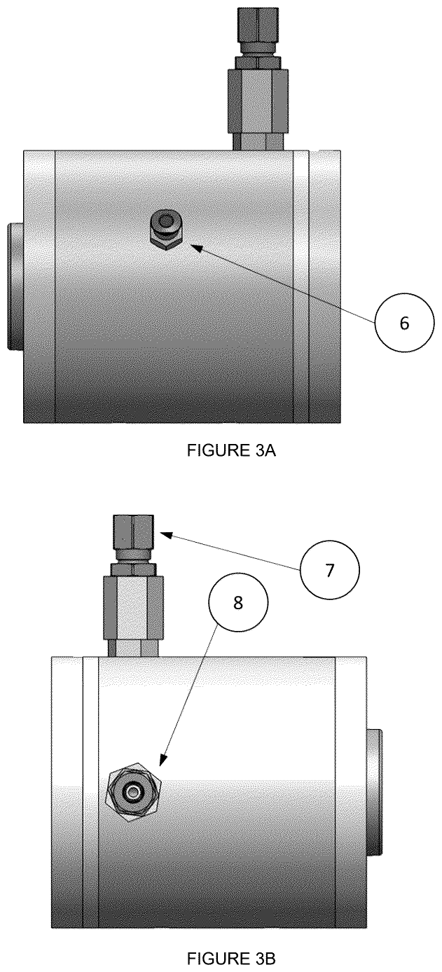

FIG. 3A shows the left side view of the cryogenics and heating device.

FIG. 3B shows the right side view of the cryogenics and heating device.

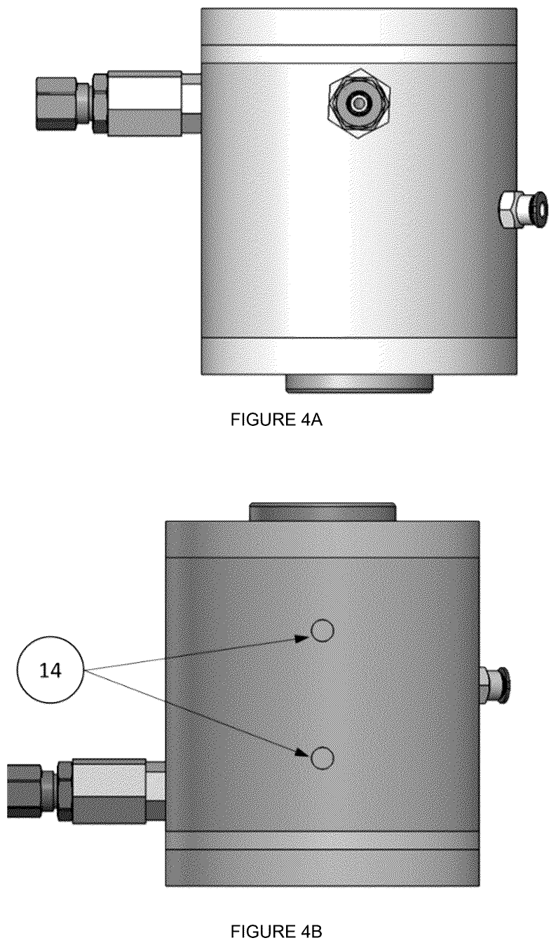

FIG. 4A shows the top view of the cryogenics and heating device.

FIG. 4B shows the bottom view of the cryogenics and heating device, highlighting the threaded holes (14) for connection to supports.

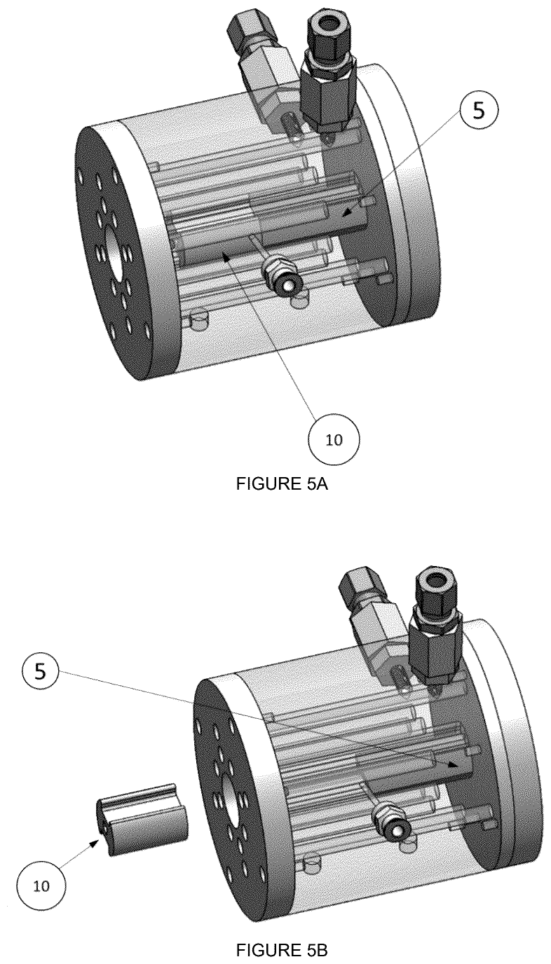

FIGS. 5A and 5B show an isometric left side perspective view of the overall structure of the cryogenics and heating device, in an arrangement with the cryogenics and heating capsule (1) that is shown transparent to show its internal details. FIG. 5A shows the specimen container (10) housed up to its positioning stop (5) and FIG. 5B shows the specimen container (10) dislodged out of the assembly.

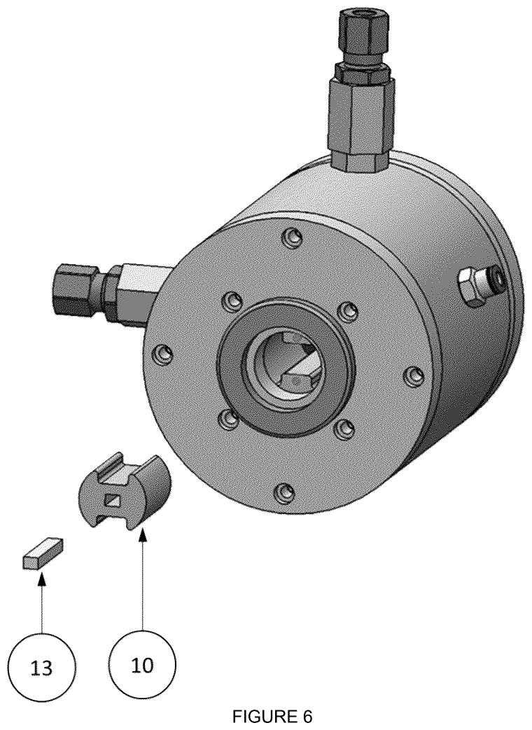

FIG. 6 shows an isometric perspective view of the overall structure of the cryogenic and heating device highlighting the container (10) for reduced-scale test specimens and a reduced-scale test specimen sample (13).

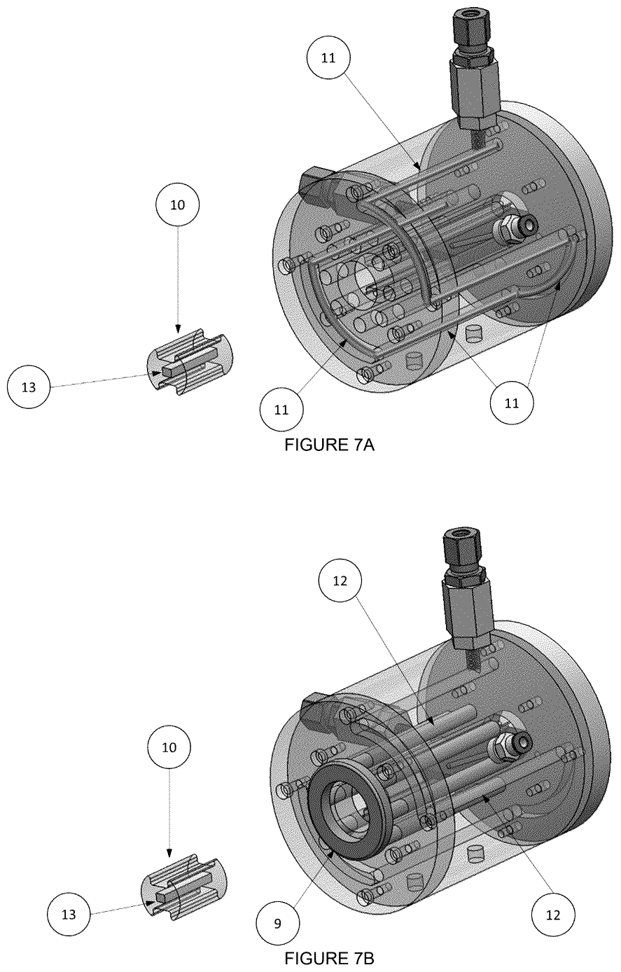

FIGS. 7A and 7B show an isometric left side perspective view of the overall structure of the cryogenics and heating device, in an arrangement with the cryogenics and heating capsule (1) which is shown transparent to show its internal details. FIG. 7A shows the cooling fluid circulation channels (11) for cryogenics with the reduced scale test specimen (13) housed in the container (10) and FIG. 7B shows the electrical resistor mounting channels (12) for heating.

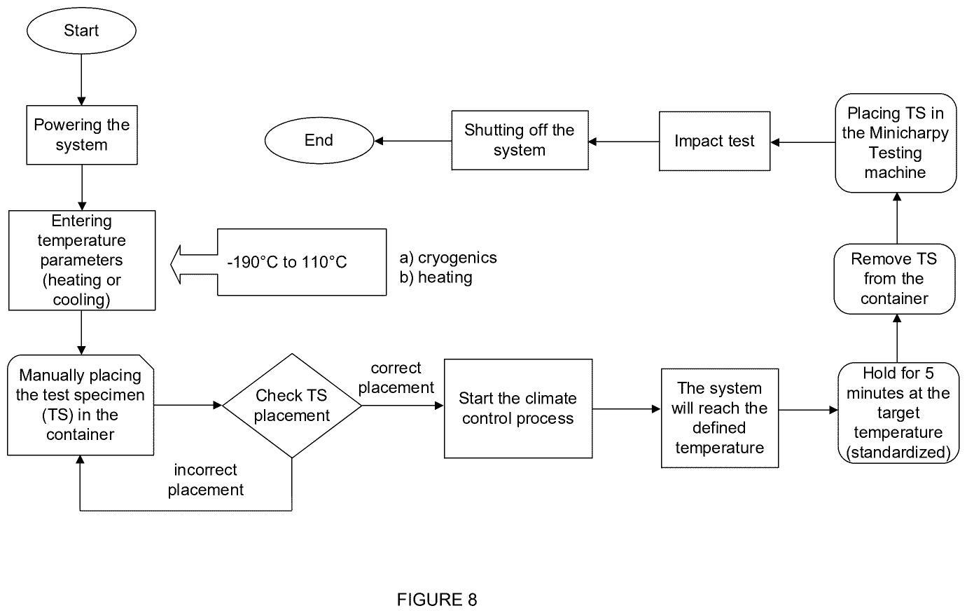

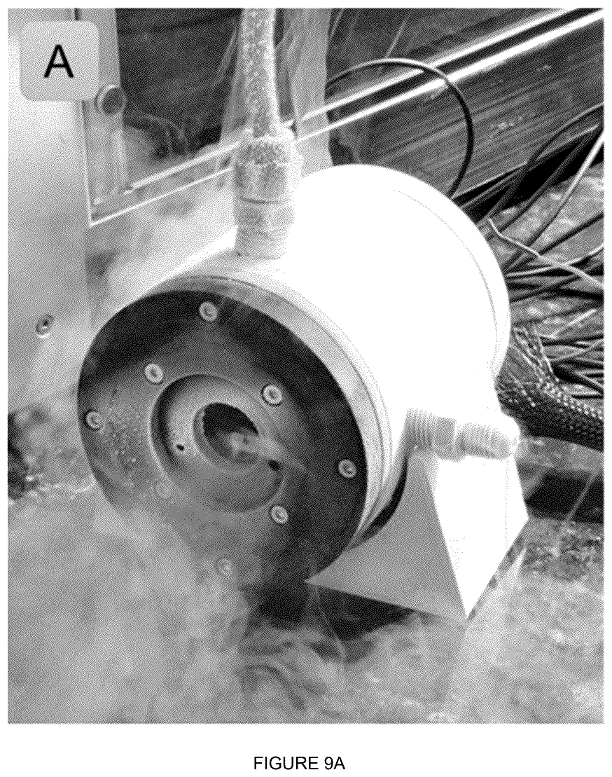

FIG. 8 shows a flowchart of the supervisory application developed for the operation of the cryogenics and heating device using a user interface.

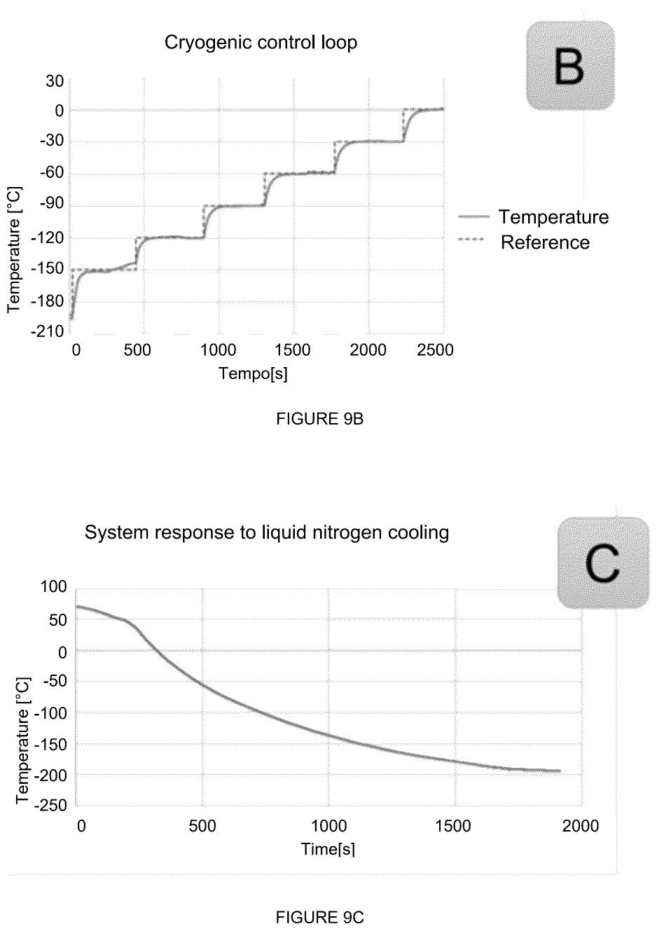

FIG. 9A shows an illustrative photo of the cryogenics and heating device.

FIG. 9B is a graph showing climate control performance.

FIG. 9C is a graph showing the development curve of the cooling system.

### DETAILED DESCRIPTION

The device for cryogenics and heating of reduced-scale test specimens for Charpy testing, which is the object of the present disclosure, is shown in FIG. 1 in an isometric perspective view with the exploded view and its components duly identified, including the cryogenics and heating capsule (1), celeron thermoelectric insulator (2), rear thermal recirculator (3), front thermal recirculator (4), container positioning stop (5), Festo-type quick-connect fitting (6) for inert gas, cooling liquid inlet hydraulic connection (7), cooling liquid outlet hydraulic connection (8), electrical resistor (9) for heating the capsule (1), reduced-scale test specimen container (10), internal fluid circulation channels (11), heating electrical resistor (12) mounting channels (12), an example of a reduced-scale test specimen (13), a pair of threaded holes (14) for connection to support bases, a pair of conditioned thermal sensors (15), and a cryogenics and heating system (16) with ESP-32 logic controller that powers the electrical resistor (9) or releases the solenoid valve of the cooling liquid cylinder.

FIG. 2 shows the front view (A) and the rear view (B) highlighting the electrical heating resistor (9), cryogenic (8) and hydraulic (7) connections, the container positioning stop (5) and CR1515 temperature sensors (15) reading between −200° C. and 850° C.

FIG. 3 shows the left side view (A) and the right side view (B), highlighting the Festo-type quick-connect fitting (6) for purging the inert gas and the cryogenic hydraulic connections (7) and (8).

FIG. 4 shows the top view (A) and in the bottom view (B) there are two threaded holes (14) to secure the assembly to a base support.

In FIGS. 5, 6 and 7, the cryogenics and heating capsule (1) is seen, which is provided with internal fluid circulation channels (11) responsible for thermal conduction, cryogenics or heating, of the container (10) of the reduced-scale test specimen (13) housed therein and protected by a celeron thermoelectric insulator (2). Cryogenic thermal conduction is assisted by a pair of rear (3) and front (4) thermal recirculators, which guide the cryogenic fluid through a path within internal channels (11) along the capsule (1), keeping it in recirculation with a pair of hydraulic inlet (7) and outlet (8) connections. A Festo-type quick-connect fitting (6) is responsible for purging an inert gas that acts as a heat exchanger, preventing defrosting from forming inside the capsule (1) and the container (10) with the test specimen (13). Heating thermal conduction consists of mounting channels (12) for the electrical resistor (9) which is subjected to a confined flow of electric current that produces the joule effect, converting electrical power into thermal energy. Placement of the reduced-scale test specimen (13) container (10) inside the capsule (1) is guided by its stylized geometric contours until it reaches the stop (5) which acts as position limiting member.

A proprietary computer program, written in Python programming language (Py) interfaces with the cryogenic and heating device for reduced-scale specimens for Charpy impact testing, and is responsible for its operational control during the thermal preparation of the test specimens (13), in the case of a supervisory application. Thermal capability for the preparation of specimens of the cryogenics and heating device spans a range from −190° C. to 110° C., and its program operation algorithm is illustrated in FIG. 8. This application receives the temperature settings desired by the operator/user through the system interface (16), parameterizing the cryogenics or heating process. With the thermal level settings defined by the user, and the container (10) with the test specimen (13) properly housed in the capsule (1), the application triggers the corresponding process, which is the delivery of cooling gas for the cryogenic loading process entering the hydraulic connection (7) and circulating through the channels (11) and recirculators (3) and (4) and exiting through the hydraulic connection (8); or the electrical actuation of the resistor (9) mounted on the channels (12) for the heating process. It also controls the purging of an inert gas into the capsule (1) by means of the Festo-type quick-connect fitting (6) to prevent thawing from forming on the test specimen (13) during the cryogenics process. Thermal sensors (15) with a conditioner are responsible for setting and maintaining the target temperature defined by the user.

FIG. 9 shows a cryogenics test (A) with the device covered by a layer of frost formed due to the cooling of the surrounding atmospheric air. Graph (B) shows its climate control performance, with the temperature curve relative to the reference values required for scientific research, for the optimal preparation of specimens and the determination of the material's ductile-brittle transition curve. Graph (C) shows the development curve of the cooling system, depicting a temperature decrease from 80° C. to −200° C., taking about 1,900 seconds (32 minutes).

1. A DEVICE FOR CRYOGENICS AND HEATING OF REDUCED-SCALE TEST SPECIMENS FOR CHARPY TESTING characterized in that it comprises a cryogenics and heating capsule (1) provided with internal channels (11) for cryogenic or heating thermal conduction, a container (10) for reduced-scale test specimens (13) housed inside it and protected by a celeron thermoelectric insulator (2), a pair of rear (3) and front (4) thermal recirculators, Festo-type quick-connect fitting (6), a pair of hydraulic inlet (7) and outlet (8) connections, a container (10) positioning stop (5), electrical resistor (9) mounting channels (12), threaded holes (14) for attachment to the support base, a pair of thermal sensors (15) connected to a cryogenics and heating system (16) with an ESP-32 controller that powers the electrical resistor (9) and/or releases the solenoid valve of the cooling fluid cylinder.

2. The CRYOGENICS AND HEATING DEVICE, according to claim 1, characterized in that the cryogenic thermal conduction is assisted by the rear (3) and front (4) thermal recirculators, which guide the cryogenic fluid through the internal channels (11) and maintain it in circulation via the hydraulic inlet (7) and outlet (8) connections, this process being monitored by thermal sensors (15) and controlled by the system (16).

3. The CRYOGENICS AND HEATING DEVICE, according to claim 1, characterized in that thermal heating conduction is carried out through the electrical resistor (9) mounting channels (12), the electrical resistor being subjected to a confined flow of electric current producing the Joule effect, converting electrical energy into thermal energy, this process being monitored by thermal sensors (15) and controlled by the system (16).

4. A TEST METHOD using the cryogenic and heating device for reduced-scale specimens as described in the preceding claims, characterized in that it is carried out using a proprietary computer program written in the Python programming language (Py), following the steps below:
a) defining the temperature parameters desired by the operator/user, to configure the cryogenics or heating process through the system (16) with a logic controller connected to thermal sensors (15);
b) manually placing the test specimen (13) into the container (10) and inserting it into the chamber (1);
c) triggering the corresponding process through the application, which is the delivery of cooling gas for the cryogenic loading process, which enters the hydraulic connection (7) and circulates through the channels (11) and recirculators (3) and (4) and exits through the hydraulic connection (8); or the electrical actuation of the resistor (9) mounted on the channels (12) for the heating process;
d) in the instance of actuation of the cryogenics process, the application controls the purging of an inert gas into the chamber (1) by means of the Festo-type quick-connect fitting (6) to prevent thawing from forming on the test specimen (13);
e) the application monitors processes, whether cryogenics or heating processes, using thermal sensors responsible for defining and holding the target temperature defined by the user;
f) upon reaching the target temperature, and holding for 5 seconds, the test specimen (13) is removed from the chamber and placed on the Charpy machine stop, where it is subjected to the impact test;
g) the application holds the target temperature in the chamber or it can be restarted to receive new settings; it is necessary to wait about 30 minutes for the cryogenics and heating device to return to room temperature. If there are no more tests to be carried out, the application shuts down the system.
